(19) United States
(12) Patent Application Publication
(10) Pub. No.: US 2018/0237570 A1
(43) Pub. Date: Aug. 23, 2018

(54) PROCESS FOR LOWERING YELLOWNESS INDEX OF POLYOLEFIN-BASED MALEIC ANHYDRIDE GRAFT COPOLYMERS AND COMPOSITIONS MADE THEREFROM

(71) Applicant: EQUISTAR CHEMICALS, LP, Houston, TX (US)

(72) Inventor: CHUN D. LEE, CINCINNATI, OH (US)

(73) Assignee: Equistar Chemicals, LP, Houston, TX (US)

(21) Appl. No.: 15/899,039

(22) Filed: Feb. 19, 2018

Related U.S. Application Data
(60) Provisional application No. 62/460,497, filed on Feb. 17, 2017.

(51) Int. Cl. C08F 255/02; C08F 8/46; C09J 123/26

(52) U.S. Cl. CPC C08F 255/02; C09J 123/26; C08F 8/46

(57) ABSTRACT

The disclosure provides a process for modifying a polyolefin-based composition including the steps of: (A) selecting a first polyolefin-based composition made from or containing a first polyolefin-based maleic anhydride graft having a yellowness index and an amount of covalently-bonded maleic anhydride substituents available for hydrolysis; (B) introducing the first polyolefin-based composition into a mixing chamber; (C) admixing water into the mixing chamber to form a water-containing polyolefin-based composition; (D) heating and agitating the water-containing polyolefin-based composition; (E) reacting the water with at least some of the maleic anhydride substituents to form maleic acid substituents, thereby yielding a modified polyolefin-based maleic anhydride graft having a yellowness index lower than the yellowness index of the first polyolefin-based maleic anhydride graft; and (F) collecting the modified polyolefin-based maleic anhydride graft, thereby yielding a modified polyolefin-based composition. The process is useful for making improved polyolefin-based maleic anhydride grafts, let-down products, and adhesives or tie-layers.

### CROSS-REFERENCE TO RELATED APPLICATIONS

This application is the Non-Provisional patent application, which claims benefit of priority to U.S. Provisional Application No. 62/460,497, filed Feb. 17, 2017, the contents of which are incorporated herein by reference in their entirety.

### FIELD OF THE INVENTION

In general, the present disclosure relates to the field of chemistry. More specifically, the present disclosure relates to polymer chemistry. In some embodiments, the present disclosure relates to polyolefin-based maleic anhydride grafts and compositions made therefrom that are useful as adhesives or tie layer resins.

### BACKGROUND OF THE INVENTION

Tie-layer adhesives are used to bond polyolefins to dissimilar substrates in multi-layer, co-extruded structures for beverage and food containers (e.g., bags, shrink bags, pouches, casings, trays, lidded trays, overwrapped trays, form shrink packages, vacuum skin packages, flow wrap packages, thermoformed packages, packaging inserts or combinations thereof), medicine and makeup containers, shipping packaging, electronic components, synthetic fibers, fiberfill applications (e.g., home insulation, cushions, and pillows), and metal laminate applications (e.g., building and construction products, business and consumer products, containers and packaging products, electrical equipment, machinery and industrial equipment, signs and displays, and transportation products). The adhesives can be used in lamination, extrusion (or coextrusion), sheet extrusion, extrusion coating, injection molding, blow molding, melt thermoforming, and other processes.

Commercial polyolefin tie layer resins can be produced using polyolefin-based maleic anhydride grafts with other polyolefin grades. Those maleated polyolefins can be produced by grafting the maleic anhydride onto the polyolefin backbone in the presence of an organic peroxide through high temperature twin screw extrusion. Unfortunately, the peroxide addition can result in an undesirable yellowness index for the polyolefin-based maleic anhydride grafts and the related let-down products.

It is desirable to provide a method for reducing the yellowness index of the polyolefin-based maleic anhydride grafts and the let-down products. It is further desirable to obtain the polyolefin-based maleic anhydride grafts, the related let-down products, and adhesives or tie-layers prepared therefrom.

### SUMMARY OF THE INVENTION

In general embodiments, the present disclosure provides a process for modifying a polyolefin-based composition including the steps of:
(A) a selection step including selecting a first polyolefin-based composition made from or containing:
   (i) a first polyolefin-based maleic anhydride graft having
      (a) a yellowness index measurable according to ASTM D6290 and subject to calculation according to ASTM E313 and
      (b) an amount of covalently-bonded maleic anhydride substituents available for hydrolysis;
(B) an introduction step including introducing the first polyolefin-based composition into a mixing chamber;
(C) a first mixing step including admixing water into the mixing chamber to form a water-containing polyolefin-based composition;
(D) a wetting step including heating and agitating the water-containing polyolefin-based composition;
(E) a reaction step including reacting the water with at least some of the maleic anhydride substituents to form maleic acid substituents, thereby yielding a modified polyolefin-based maleic anhydride graft having a yellowness index lower than the yellowness index of the first polyolefin-based maleic anhydride graft; and
(F) a collection step including collecting the modified polyolefin-based maleic anhydride graft, thereby yielding a modified polyolefin-based composition.

In some embodiments, the present disclosure provides a process for modifying a polyolefin-based composition including the steps of:
(A) a selection step including selecting a first polyolefin-based composition made from or containing:
(i) a first polyolefin-based maleic anhydride graft having
   (a) a yellowness index measurable according to ASTM D6290 and subject to calculation according to ASTM E313 and
   (b) an amount of covalently-bonded maleic anhydride substituents available for hydrolysis;
(B) an introduction step including introducing the first polyolefin-based composition into a mixing chamber;
(C) a first mixing step including admixing water into the mixing chamber to form a water-containing polyolefin-based composition;
(D) a wetting step including heating and agitating the water-containing polyolefin-based composition;
(E) a reaction step including reacting the water with at least some of the maleic anhydride substituents to form maleic acid substituents, thereby yielding a modified polyolefin-based maleic anhydride graft having a yellowness index lower than the yellowness index of the first polyolefin-based maleic anhydride graft;
(F) a collection step including collecting the modified polyolefin-based maleic anhydride graft, thereby yielding a modified polyolefin-based composition; and
(G) a second mixing step including admixing a second polyolefin-based composition made from or containing a second polyolefin, thereby yielding a let-down product of the polyolefin-based maleic anhydride graft and further modifying the modified polyolefin-based composition.

In some embodiments, the present disclosure provides a modified polyolefin-based composition prepared by a process including the steps of:
(A) a selection step including selecting a first polyolefin-based composition made from or containing:
   (i) a first polyolefin-based maleic anhydride graft having
      (a) a yellowness index measurable according to ASTM D6290 and subject to calculation according to ASTM E313 and
      (b) an amount of covalently-bonded maleic anhydride substituents available for hydrolysis;
(B) an introduction step including introducing the first polyolefin-based composition into a mixing chamber;
(C) a first mixing step including admixing water into the mixing chamber to form a water-containing polyolefin-based composition;
(D) a wetting step including heating and agitating the water-containing polyolefin-based composition;
(E) a reaction step including reacting the water with at least some of the maleic anhydride substituents to form maleic acid substituents, thereby yielding a modified polyolefin-based maleic anhydride graft having a yellowness index lower than the yellowness index of the first polyolefin-based maleic anhydride graft; and
(F) a collection step including collecting the modified polyolefin-based maleic anhydride graft, thereby yielding a modified polyolefin-based composition.

In some embodiments, the present disclosure provides a modified polyolefin-based composition prepared by a process including the steps of:
(A) a selection step including selecting a first polyolefin-based composition made from or containing:
   (i) a first polyolefin-based maleic anhydride graft having
      (a) a yellowness index measurable according to ASTM D6290 and subject to calculation according to ASTM E313 and
      (b) an amount of covalently-bonded maleic anhydride substituents available for hydrolysis;
(B) an introduction step including introducing the first polyolefin-based composition into a mixing chamber;
(C) a first mixing step including admixing water into the mixing chamber to form a water-containing polyolefin-based composition;
(D) a wetting step including heating and agitating the water-containing polyolefin-based composition;
(E) a reaction step including reacting the water with at least some of the maleic anhydride substituents to form maleic acid substituents, thereby yielding a modified polyolefin-based maleic anhydride graft having a yellowness index lower than the yellowness index of the first polyolefin-based maleic anhydride graft;
(F) a collection step including collecting the modified polyolefin-based maleic anhydride graft, thereby yielding a modified polyolefin-based composition; and
(G) a second mixing step including admixing a second polyolefin-based composition made from or containing a second polyolefin, thereby yielding a let-down product of the polyolefin-based maleic anhydride graft and further modifying the modified polyolefin-based composition.

In some embodiments, the present disclosure provides a tie-layer adhesive made from or containing the modified polyolefin-based composition.

In some embodiments, the present disclosure provides a multi-layered structure made from or containing
(A) a tie-layer adhesive made from or containing the modified polyolefin-based composition;
(B) a polymer layer; and
(C) a substrate layer.

While multiple embodiments are disclosed, still other embodiments will become apparent to those skilled in the art from the following detailed description. As will be apparent, certain embodiments, as disclosed herein, are capable of modifications in various obvious aspects, all without departing from the spirit and scope of the claims as presented herein. Accordingly, the drawings and detailed description are to be regarded as illustrative in nature and not restrictive.

### DESCRIPTION OF THE DRAWINGS

The following figures illustrate certain embodiments of the subject matter disclosed herein. The claimed subject matter may be understood by reference to the following description taken in conjunction with the accompanying figures, in which like reference numerals identify like elements, and in which:

FIG. 1 shows two superimposed spectra obtained from the Fourier Transform Infrared Spectroscopy analyses of (i) a polypropylene-based maleic anhydride graft (i.e., the first polypropylene-based maleic anhydride graft) and (ii) a batch-process treated polypropylene-based maleic anhydride graft (i.e., the modified polypropylene-based maleic anhydride graft).

FIG. 2 shows two superimposed spectra obtained from the Fourier Transform Infrared Spectroscopy analyses of (i) a let-down composition made from or containing a polypropylene-based maleic anhydride graft and (ii) a continuous-process (extrusion) treated let-down composition made from or containing a polypropylene-based maleic anhydride graft.

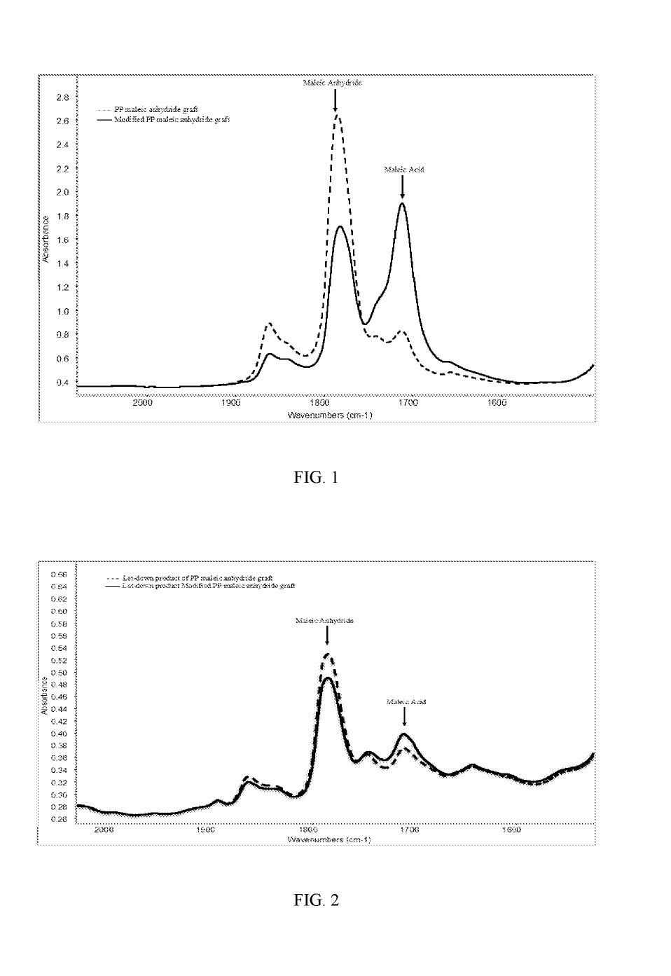

### DETAILED DESCRIPTION OF THE INVENTION

The present disclosure now will be described more fully hereinafter. However, this disclosure can be embodied in many different forms and should not be construed as limited to the embodiments set forth herein; rather, these embodiments are provided so that this disclosure will satisfy applicable legal requirements. As such, it will be apparent to those skilled in the art that the embodiments can incorporate changes and modifications without departing from the general scope. It is intended to include all the modifications and alterations in so far as the modifications and alterations come within the scope of the appended claims or the equivalents thereof.

As used in this specification and the claims, the singular forms “a,” “an,” and “the” include plural referents unless the context clearly dictates otherwise.

As used in this specification and the claims, the terms “comprising,” “containing,” or “including” mean that at least the named compound, element, material, particle, or method step, etc., is present in the composition, the article, or the method, but does not exclude the presence of other compounds, elements, materials, particles, or method steps, etc., even if the other such compounds, elements, materials, particles, or method steps, etc., have the same function as that which is named, unless expressly excluded in the claims. It is also to be understood that the mention of one or more method steps does not preclude the presence of additional method steps before or after the combined recited steps or intervening method steps between those steps expressly identified.

Moreover, it is also to be understood that the lettering of process steps or ingredients is a means for identifying discrete activities or ingredients and the recited lettering can be arranged in any sequence, unless expressly indicated.

For the purpose of the present description and of the claims which follow, except where otherwise indicated, numbers expressing amounts, quantities, percentages, and so forth, are to be understood as being modified by the term “about”. Also, ranges include any combination of the maximum and minimum points disclosed and include any intermediate ranges therein, which may or may not be specifically enumerated herein.

### Definitions

In the present description, the term “additives composition” refers to a composition made from or containing at least one additive.

In the present description, the terms “adhesive layer” and “tie layer” mean a layer or material placed on one or more substrates to promote the adhesion of that substrate to another layer. Adhesive layers can be positioned between two layers of a multilayer structure to maintain the two layers in position relative to each other and prevent delamination.

In the present description, the term “α-olefin” or “alpha-olefin” means an olefin of formula CH₂=CH—R, wherein R is a linear or branched alkyl containing from 1 to 10 carbon atoms. The α-olefin can be selected, for example, from: propylene, 1-butene, 1-pentene, 1-hexene, 1-octene, 1-dodecene and the like.

In the present description, the term “elastomer” refers to polymer compounds having rubber-like properties and crystallinity in the range of from about 0 percent to about 20 percent.

In the present description, the term “first” refers to the order in which a species is presented and does not necessarily indicate that a “second” species will be presented. For example, “first polymer composition” refers to the first of at least one polymer composition. The term does not reflect priority, importance, or significance in any other way. Similar terms used that can be used herein include “second,” “third,” “fourth,” etc.

In the present description, the term “grafted polyolefin” or “polyolefin-based graft” refers to a polyolefin grafted with an unsaturated monomer. The unsaturated monomer can be an unsaturated polar monomer and contain one or more oxygen atoms.

In the present description, the term “homopolymer” as used herein is consistent with its ordinary meaning. To the extent that a homopolymer can contain one or more monomeric units, the incorporation of any additional monomeric units has no measurable effect on the polymer's primary, secondary or tertiary structure or no effect on the polymer's physical or chemical properties. In other words, there is no measureable difference between a polymer comprising 100 weight percent of a first monomeric unit, and a co-polymer that includes more than one monomeric units.

In the present description, the terms “monomer” and “comonomer” are used interchangeably. The terms mean any compound with a polymerizable moiety that is added to a reactor in order to produce a polymer. In those instances in which a polymer is described as comprising one or more monomers, e.g., a polymer comprising propylene and ethylene, the polymer, of course, comprises units derived from the monomers, e.g., —CH₂—CH₂—, and not the monomer itself, e.g., CH₂═CH₂.

In the present description, “plastic film packaging” is discussed throughout this description. To faciliate that discussion, various polymer acronyms are used herein. When referring to blends of polymers, the description can use a colon (:) to indicate that the components to the left and right of the colon are blended. When referring to a multi-layer structure, the description can use a slash “/” to indicate that components to the left and right of the slash are in different layers and the relative position of components in layers can be so indicated by use of the slash to indicate layer boundaries.

Acronyms commonly employed herein include:
EAA: Copolymer of ethylene with acrylic acid
EAO: Copolymers of ethylene with at least one alpha-olefin
EBA: Copolymer of ethylene with butyl acrylate
EEA: Copolymer of ethylene with ethyl acrylate
EMA: Copolymer of ethylene with methyl acrylate
EMAA: Copolymer of ethylene with methacrylic acid
EVA: Copolymer of ethylene with vinyl acetate
EVOH: Saponified or hydrolyzed copolymer of ethylene and vinyl acetate
PB: Polybutylene-1 (a butylene homopolymer or copolymer of a major portion of butylene-1 with one or more alpha-olefins)
PE: Polyethylene (an ethylene homopolymer or copolymer of a major portion of ethylene with one or more alpha-olefins)
PP: Polypropylene homopolymer or copolymer
PET: Polyethylene terephthalate
PETG: Glycol-modified polyethylene terephthalate
PLA: Polylactic acid
PVDC: Polyvinylidene chloride (also includes copolymers of vinylidene chloride, especially with vinyl chloride or methyl acrylate (MA)).

In the present description, the term “polymer” means a macromolecular compound prepared by polymerizing monomers of the same or different type. The term “polymer” includes homopolymers, copolymers, terpolymers, interpolymers, and so on.

In the present description, the term “polymer composition” refers to a composition made from or containing at least one polymer.

In the present description, the term “polyolefin” is used herein broadly to include polymers such as polyethylene, ethylene-alpha olefin copolymers (EAO), polypropylene, polybutene, and ethylene copolymers having at least about 50 percent by weight of ethylene polymerized with a lesser amount of a comonomer such as vinyl acetate, and other polymeric resins within the “olefin” family classification.

Polyolefins can be made by a variety of processes including batch and continuous processes using single, staged, or sequential reactors, slurry, solution, and fluidized bed processes and one or more catalysts including for example, heterogeneous and homogeneous systems and Ziegler, Phillips, metallocene, single-site, and constrained geometry catalysts to produce polymers having different combinations of properties.

Testing

ASTM D 792 is entitled “Test Methods for Density and Specific Gravity (Relative Density) of Plastics by Displacement.” The term “ASTM D 792” as used herein refers to the standard test method for determining the specific gravity (relative density) and density of solid plastics in forms such as sheets, rods, tubes, or molded items. The test method includes determining the mass of a specimen of the solid plastic in air, determining the apparent mass of the specimen upon immersion in a liquid, and calculating the specimen's specific gravity (relative density). This test method was approved on Jun. 15, 2008 and published July 2008, the contents of which are incorporated herein by reference in its entirety.

ASTM D 1238 is entitled “Test Method for Melt Flow Rates of Thermoplastics by Extrusion Plastometer.” The term “ASTM D 1238” as used herein refers to a test method covering the determination of the rate of extrusion of molten thermoplastic resins using an extrusion plastometer. After a specified preheating time, resin is extruded through a die with a specified length and orifice diameter under prescribed conditions of temperature, load, and piston position in the barrel. This test method was approved on Feb. 1, 2012 and published March 2012, the contents of which are incorporated herein by reference in its entirety.

Throughout the present description and claims, the standard melt index values of polyethylene polymers are measured according to ASTM D 1238, using a piston load of 2.16 kg and at a temperature of 190 degrees Celsius.

Throughout the present description and claims, the standard melt flow rate values of polypropylene polymers are measured according to ASTM D 1238, using a piston load of 2.16 kg and at a temperature of 230 degrees Celsius.

ASTM D 1505 is entitled “Standard Test Method for Density of Plastics by the Density-Gradient Technique.” The term “ASTM D 1505” as used herein refers to a test method based on observing the level to which a test specimen sinks in a liquid column exhibiting a density gradient, in comparison with standards of known density. This test method was approved on Jul. 1, 2010 and published September 2010, the contents of which are incorporated herein by reference in its entirety.

ASTM D6290 is entitled “Standard Test Method for Color Determination of Plastic Pellets.” The term “ASTM D6290” as used herein refers to the instrumental measurement of the degree of yellowness (or change of degree of yellowness) under daylight illumination of homogeneous, non-fluorescent, nearly-colorless transparent or nearly-white translucent or opaque plastics. The measurement is made on pellets and based on tristimulus values obtained with a spectrophotometer or colorimeter. This test method is applicable to the color analysis of plastic pellets. This test method was approved in 2013, the contents of which are incorporated herein by reference in its entirety.

ASTM E313 is entitled “Standard Practice for Calculating Yellowness and Whiteness Indices from Instrumentally Measured Color Coordinates.” The term “ASTM E 313” as used herein refers to the practice (a) for providing numbers that correlate with visual ratings of yellowness or whiteness of white and near-white or colorless object-color specimens, viewed in daylight by an observer with normal color vision, and (b) provides recommended equations for single-number scales of yellowness or whiteness and discusses their derivations and uses, and limits to their applicability. This test method was approved in 2015, the contents of which are incorporated herein by reference in its entirety.

For the referenced ASTM standards, visit the ASTM website, www.astm.org, or contact ASTM Customer Service at service@astm.org.

Conversion of Maleic Anhydride Substituents to Maleic Acid Substituents: The amount of the unsaturated monomer incorporated into the grafted polyolefin can be measured by Fourier transform infrared spectroscopy (FTIR). Also, the amount of conversion of the unsaturated monomer from its anhydride form to its acid form can be measured by FTIR. The maleic anhydride substituent shows absorbance at 1785 cm⁻¹ while the maleic acid substituent shows absorbance at 1710 cm⁻¹.

In general embodiments, the present disclosure provides a process for modifying a polyolefin-based composition including the steps of:
(A) a selection step including selecting a first polyolefin-based composition made from or containing:
   (i) a first polyolefin-based maleic anhydride graft having
      (a) a yellowness index measurable according to ASTM D6290 and subject to calculation according to ASTM E313 and
      (b) an amount of covalently-bonded maleic anhydride substituents available for hydrolysis;
(B) an introduction step including introducing the first polyolefin-based composition into a mixing chamber;
(C) a first mixing step including admixing water into the mixing chamber to form a water-containing polyolefin-based composition;
(D) a wetting step including heating and agitating the water-containing polyolefin-based composition;
(E) a reaction step including reacting the water with at least some of the maleic anhydride substituents to form maleic acid substituents, thereby yielding a modified polyolefin-based maleic anhydride graft having a yellowness index lower than the yellowness index of the first polyolefin-based maleic anhydride graft; and
(F) a collection step including collecting the modified polyolefin-based maleic anhydride graft, thereby yielding a modified polyolefin-based composition.

The First Polyolefin-Based Composition: A First Polyolefin-Based Maleic Anhydride Graft

The polyolefin-based maleic anhydride graft can be prepared by reacting a polyolefin with a maleic anhydride monomer at elevated temperatures, with or without a free-radical initiator, under conditions effective to graft the maleic anhydride monomer units onto the olefinic polymer backbone. The grafting of the maleic anhydrided monomer units onto the polyolefin yields covalently-bonded maleic anhydride substituents. The grafting reaction may occur under an inert gas, such as nitrogen.

The relative amounts of polyolefin and maleic anhydride monomer used will vary and depend on factors such as the desired tie-layer properties, the reaction conditions, the available equipment, and other factors. In some embodiments, the maleic anhydride monomer is used in an amount within the range of about 0.1 to about 15 weight percent, based on the total weight of the grafted polyolefin. In other embodiments, the maleic anhydride monomer is used in an amount from about 0.5 to about 6 weight percent. In yet other embodiments, the maleic anhydride monomer is used in an amount from about 1 to about 3 weight percent. In still other embodiments, the maleic anhydride monomer is present in 1.1, 1.2, 1.3, 1.4, 1.5, 1.6, 1.7, 1.8, 1.9, 2.0, 2.1, 2.2, 2.3, 2.4, or 2.5 weight percent.

Grafting of the maleic anhydride monomer to the olefinic polymer can be accomplished by heating a mixture of the maleic anhydride monomer and the polyolefin. The grafted polyolefin can be prepared by melt blending the polyolefin with the maleic anhydride monomer in a shear-imparting extruder/reactor. Twin screw extruders such as those marketed by Coperion under the designations ZSK-53, ZSK-83, ZSK-90 and ZSK-92 are especially useful for performing the grafting step. A free-radical initiator such as an organic peroxide can be employed.

Among other factors, it is believed that the peroxide addition can result in an undesirable yellowness index for the polyolefin-based maleic anhydride grafts. The yellowness index is measurable according to ASTM D6290 and subject to calculation according to ASTM E313.

Grafting of the maleic anhydride monomer to the polyolefin is performed at elevated temperatures. Shear rates in the extruder can vary over a wide range.

In some embodiments, the polyolefin-based maleic anhydride graft for use in the first polyolefin-based composition can be a polyethylene-based maleic anhydride graft or a polypropylene-based maleic anhydride graft.

When the polyolefin-based maleic anhydride graft is a polyethylene-based maleic anhydride graft, examples of ethylene polymers for making the polyethylene-based maleic anhydride graft include high density polyethylenes (HDPE), medium density polyethylenes (MDPE), low density polyethylenes (LDPE), linear low density polyethylenes (LLDPE), and the like, and blends thereof. In some embodiments, the ethylene polymer is an HDPE.

In some embodiments, the ethylene polymer grafted with the maleic anhydride monomer has a density in the range of about 0.80 to about 0.98 grams per cubic centimeter. In other embodiments, the density is in the range of about 0.85 to about 0.96 grams per cubic centimeter.

In some embodiments, the ethylene polymer grafted with the maleic anhydride monomer has a melt index in the range of about 2.0 to about 50 grams per 10 minutes, measured according to ASTM D 1238, using a piston load of 2.16 kg and at a temperature of 190 degrees Celsius. In other embodiments, the melt index is in the range of about 5.0 to about 20 grams per 10 minutes. In still other embodiments, the melt index is 5, 6, 7, 8, 9, 10, 11, 12, 13, 14, 15, 16, 17, 18, 19, 20, or an intermediate melt index.

When the polyolefin-based maleic anhydride graft is a polypropylene-based maleic anhydride graft, examples of propylene polymers for making the polypropylene-based maleic anhydride graft include propylene homopolymers, random propylene copolymers, impact propylene copolymers, and the like, and blends thereof.

In some embodiments, the polypropylene grafted with the maleic anhydride monomer has a density in the range of about 0.80 to about 0.95 grams per cubic centimeter. In other embodiments, the density is in the range of about 0.85 to about 0.92 grams per cubic centimeter.

In some embodiments, the polypropylene grafted with the maleic anhydride monomer has a melt flow rate in the range of about 10 to about 700 grams per 10 minutes, measured according to ASTM D 1238, using a piston load of 2.16 kg and at a temperature of 230 degrees Celsius. In other embodiments, the melt flow rate is in the range of about 30 to about 500 grams per 10 minutes. In still other embodiments, the melt flow rate is 30, 50, 100, 150, 200, 250, 350, 400, 450, 500, or an intermediate melt flow rate.

Hydrolysis: Conversion of Maleic Anhydride Substituents to Maleic Acid Substituents

The hydrolysis of maleic anhydride to maleic acid occurs pursuant to the following reaction:

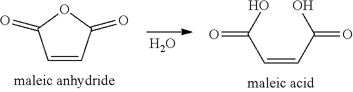

When the polyolefin-based maleic anhydride graft is polyethylene-based maleic anhydride graft, the hydrolysis reaction is believed to be as follows:

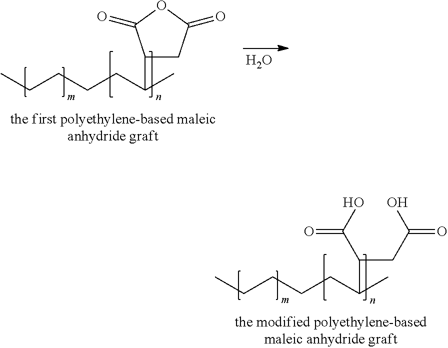

Similarly, when the polyolefin-based maleic anhydride graft is polypropylene-based maleic anhydride graft, the hydrolysis reaction is believed to be as follows:

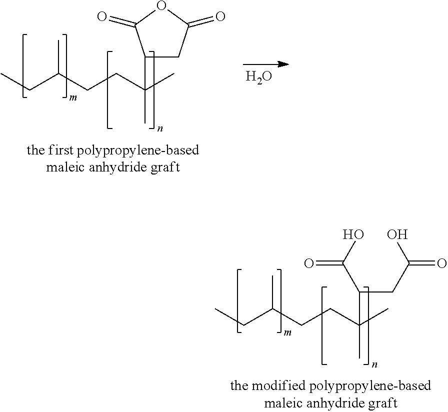

In any of the hydrolysis reactions, the reaction can proceed when water is present and the maleic anhydride substituent is accessible by the water molecule. The level of hydrolysis can be controlled based upon the amount of water added in reference to the quantity of maleic anhydride substituents available for hydrolysis. In some embodiments, the water can be added in an amount less than the quantity of maleic anhydride substituents. In other embodiments, the water can be added in an amount in excess of the quantity of maleic anhydride substituents. In other embodiments, the water is added in an amount at least stoichiometric to the amount of the covalently-bonded maleic anhydride substituents available for hydrolysis.

The Mixing Chamber

Any suitable mixing chamber may be used for combining the polyolefin-based maleic anhydride graft with the water, depending upon the desired process. The process can be a batch process or a continuous process.

In some embodiments, the process can be a batch process wherein all the steps of combining of the introducing of the first polyolefin-based composition into the mixing chamber, the admixing of the water, the heating and agitating of the water-containing polyolefin-based composition, and the reacting of the water with the maleic anhydride substituents occur in a single chamber, reactor, or vessel or in a staged process.

In other embodiments, the process can be a continuous process as would occur through the use of an extruder, wherein each component could be added in various zones of the extruder and each process step could be performed in various zones as the reactive composition is prepared, heated and agitated, permitted to complete the reaction, and then converted to the reaction products for collection.

The Modified Polyolefin-Based Composition: A Modified Polyolefin-Based Maleic Anhydride Graft

The modified polyolefin-based composition will be made from or contain a modified polyolefin-based maleic anhydride graft having a yellowness index lower than the yellowness index of the first polyolefin-based maleic anhydride graft. In some embodiments, the modified polyolefin-based maleic anhydride graft has a yellowness index less than about 75. In other embodiments, the modified polyolefin-based maleic anhydride graft has a yellowness index less than about 65. In other embodiments, the modified polyolefin-based maleic anhydride graft has a yellowness index less than about 50. In other embodiments, the modified polyolefin-based maleic anhydride graft has a yellowness index in the range from about 1 to about 50.

In some embodiments, the modified polyolefin-based maleic anhydride graft has a yellowness index that is at least 20% lower than the yellowness index of its corresponding first polyolefin-based maleic anhydride graft. In other embodiments, the yellowness index of the modified polyolefin-based maleic anhydride graft is at least 30% lower than the yellowness index of its corresponding first polyolefin-based maleic anhydride graft. In still other embodiments, the yellowness index of the modified polyolefin-based maleic anhydride graft is at least 45% lower than the yellowness index of its corresponding first polyolefin-based maleic anhydride graft. In other embodiments, the yellowness index of the modified polyolefin-based maleic anhydride graft is in the range of about 5 to about 55 percent of the yellowness index of its corresponding first polyolefin-based maleic anhydride graft.

The Modified Polyolefin-Based Composition: A Let-Down Product of a Polyolefin-Based Maleic Anhydride Graft

In some embodiments, the present disclosure provides a process for modifying a polyolefin-based composition including the steps of:
(A) a selection step including selecting a first polyolefin-based composition made from or containing:
   (i) a first polyolefin-based maleic anhydride graft having
      (a) a yellowness index measurable according to ASTM D6290 and subject to calculation according to ASTM E313 and
      (b) an amount of covalently-bonded maleic anhydride substituents available for hydrolysis;
(B) an introduction step including introducing the first polyolefin-based composition into a mixing chamber;
(C) a first mixing step including admixing water into the mixing chamber to form a water-containing polyolefin-based composition;
(D) a wetting step including heating and agitating the water-containing polyolefin-based composition;
(E) a reaction step including reacting the water with at least some of the maleic anhydride substituents to form maleic acid substituents, thereby yielding a modified polyolefin-based maleic anhydride graft having a yellowness index lower than the yellowness index of the first polyolefin-based maleic anhydride graft;
(F) a collection step including collecting the modified polyolefin-based maleic anhydride graft, thereby yielding a modified polyolefin-based composition; and
(G) a second mixing step including admixing a second polyolefin-based composition made from or containing a second polyolefin, thereby yielding a let-down product of the modified polyolefin-based maleic anhydride graft and further modifying the modified polyolefin-based composition.

In an embodiment, the first polyolefin-based composition is present in an amount less than about 20 weight percent, relative to the total weight of the modified polyolefin-based composition. The first polyolefin-based composition can be present in an amount from about 1 to about 15 weight percent. In some embodiments, the first polyolefin-based composition can be present in an amount from about 5 to about 12 weight percent. In other embodiments, the first polyolefin-based composition can be present in 5, 6, 7, 8, 9, 10, 11, 12, or an intermediate weight percent, relative to the total weight of the modified polyolefin-based composition.

In an embodiment, the second polyolefin-based composition is present in an amount greater than about 80 weight percent, relative to the total weight of the modified polyolefin-based composition. The second polyolefin-based composition can be present in an amount from about 85 to about 99 weight percent. In some embodiments, the second polyolefin-based composition can be present in an amount from about 88 to about 95 weight percent. In other embodiments, the second polyolefin-based composition can be present in 88, 89, 90, 91, 92, 93, 94, 95, or an intermediate weight percent, relative to the total weight of the modified polyolefin-based composition.

In some embodiments, when the polyolefin-based maleic anhydride graft is a polyethylene-based maleic anhydride, the second polyolefin is a linear low density polyethylene. In the present description, the linear low-density polyethylene (LLDPE) is defined as having a density from about 0.910 to about 0.925 grams per cubic centimeter.

In some embodiments, when the polyolefin-based maleic anhydride graft is a polypropylene-based maleic anhydride, the second polyolefin is a propylene polymer selected from the group consisting of propylene homopolymers, propylene random copolymers, and propylene impact copolymers.

In some embodiments, the let-down product of the polyolefin-based maleic anhydride graft has a yellowness index less than about 30. In other embodiments, the let-down product of the polyolefin-based maleic anhydride graft has a yellowness index less than about 25. In other embodiments, the let-down product of the polyolefin-based maleic anhydride graft has a yellowness index less than about 15. In other embodiments, the let-down product of the polyolefin-based maleic anhydride graft has a yellowness index in the range of about 1 to about 15.

In some embodiments, the let-down product of the polyolefin-based maleic anhydride graft has a yellowness index that is at least 20% lower than the yellowness index of a corresponding let-down product of the first polyolefin-based maleic anhydride graft prepared in the substantial absence of water wherein the corresponding let-down product is prepared via the same process conditions and to the same let-down concentration. In other embodiments, the yellowness index of the modified polyolefin-based maleic anhydride graft is at least 30% lower than the yellowness index of a corresponding let-down product. In still other embodiments, the yellowness index of the modified polyolefin-based maleic anhydride graft is at least 45% lower than the yellowness index of a corresponding let-down product.

The Modified Polyolefin-Based Composition

In some embodiments, the present disclosure provides a modified polyolefin-based composition prepared by a process including the steps of:
(A) a selection step including selecting a first polyolefin-based composition made from or containing:
   (i) a first polyolefin-based maleic anhydride graft having
      (a) a yellowness index measurable according to ASTM D6290 and subject to calculation according to ASTM E313 and
      (b) an amount of covalently-bonded maleic anhydride substituents available for hydrolysis;
(B) an introduction step including introducing the first polyolefin-based composition into a mixing chamber;
(C) a first mixing step including admixing water into the mixing chamber to form a water-containing polyolefin-based composition;
(D) a wetting step including heating and agitating the water-containing polyolefin-based composition;
(E) a reaction step including reacting the water with at least some of the maleic anhydride substituents to form maleic acid substituents, thereby yielding a modified polyolefin-based maleic anhydride graft having a yellowness index lower than the yellowness index of the first polyolefin-based maleic anhydride graft; and
(F) a collection step including collecting the modified polyolefin-based maleic anhydride graft, thereby yielding a modified polyolefin-based composition.

The Let-Down Product

In some embodiments, the present disclosure provides a modified polyolefin-based composition prepared by a process including the steps of:
(A) a selection step including selecting a first polyolefin-based composition made from or containing:
   (i) a first polyolefin-based maleic anhydride graft having
      (a) a yellowness index measurable according to ASTM D6290 and subject to calculation according to ASTM E313 and
      (b) an amount of covalently-bonded maleic anhydride substituents available for hydrolysis;
(B) an introduction step including introducing the first polyolefin-based composition into a mixing chamber;
(C) a first mixing step including admixing water into the mixing chamber to form a water-containing polyolefin-based composition;
(D) a wetting step including heating and agitating the water-containing polyolefin-based composition;
(E) a reaction step including reacting the water with at least some of the maleic anhydride substituents to form maleic acid substituents, thereby yielding a modified polyolefin-based maleic anhydride graft having a yellowness index lower than the yellowness index of the first polyolefin-based maleic anhydride graft;
(F) a collection step including collecting the modified polyolefin-based maleic anhydride graft, thereby yielding a modified polyolefin-based composition; and
(G) a second mixing step including admixing a second polyolefin-based composition made from or containing a second polyolefin, thereby yielding a let-down product of the modified polyolefin-based maleic anhydride graft and further modifying the modified polyolefin-based composition.

The Tie-Layer Adhesive

In some embodiments, the present disclosure provides a tie-layer adhesive made from or containing the modified polyolefin-based composition.

The Multi-Layered Structure

In some embodiments, the present disclosure provides a multi-layered structure made from or containing
(A) a tie-layer adhesive made from or containing the modified polyolefin-based composition;
(B) a polymer layer; and
(C) a substrate layer.

Tie-layer adhesives can be used in numerous multi-layer constructions, including structures having five, seven, nine, or more layers.

In some embodiments, the present disclosure provides a multi-layered structure made from and/or containing a tie-layer adhesive, wherein the tie-layer adhesive is made from and/or contains a polyolefin-based composition. A multi-layer structure can be made by many methods or processes, including by coextrusion, coating, and other laminating processes.

Multi-layer structures, typically made by coextrusion, frequently include a polyolefin layer such as PP, LDPE, LLDPE, HDPE, EVA, ethylene-acrylic acid copolymers, ethylene-methacrylic acid copolymers, ethylene-acrylic acid ester copolymers, ethylene-methacrylic acid ester copolymers, ionomers, and the like. Barrier resins used are typically polar polymers such as ethylene-vinyl alcohol (EVOH) or polyamide resins such as nylon.

Illustrative multi-layer constructions include the following:
PP/adhesive/EVOH/adhesive/PP
PP/adhesive/polyamide/adhesive/PP
PP/adhesive/polyamide/EVOH/polyamide/adhesive/PP
HDPE/adhesive/EVOH/adhesive/HDPE
HDPE/adhesive/polyamide/adhesive/HDPE
EVOH/adhesive/HDPE/adhesive/EVOH
LDPE/adhesive/polyamide/adhesive/LDPE
LDPE/adhesive/EVOH/adhesive/LDPE
LLDPE/adhesive/EVOH/adhesive/LLDPE
LLDPE/adhesive/polyamide/adhesive/LLDPE
HDPE/adhesive/polyamide/EVOH/polyamide/adhesive/HDPE

Some commonly used sealable multilayer constructions include:
LLDPE/adhesive/EVOH/adhesive/sealant
HDPE/adhesive/polyamide/adhesive/sealant
HDPE/adhesive/EVOH/adhesive/sealant where the sealant layer is, for example, EVA, LLDPE or ionomer.

### EXAMPLES

The following examples are included to demonstrate embodiments. It should be appreciated by those of skill in the art that the techniques disclosed in the examples which follow represent techniques discovered to function well, and thus can be considered to constitute exemplary modes of practice. However, those of skill in the art should, in light of the present disclosure, appreciate that many changes can be made in the specific embodiments which are disclosed and still obtain a like or similar result without departing from the spirit and scope of this disclosure.

### Batch Process Examples

For each example of the batch process, a sample of polyolefin-based maleic anhydride graft was selected and placed into a one-quart jar. An amount of water, having a weight equal to about 1 weight percent of the polyolefin-based maleic anhydride graft, was added to the jar. An infrared lamp was used as a heat source to obtain gradual heating for thirty minutes. After the heating cycle was complete, the resulting reaction product was analyzed by Fourier Transform Infrared Analysis and for its yellowness index (YI).

The samples for evaluation were prepared from the following polyolefin-based maleic anhydride grafts:
Lyondell Basell PMG2372 polyethylene maleic anhydride graft, having a melt index of about 7 grams per 10 minutes and maleic anhydride content of about 1.7 weight percent
Lyondell Basell PMG2472 polyethylene maleic anhydride graft, having a melt index of about 7 grams per 10 minutes and maleic anhydride content of about 1.65 weight percent
Lyondell Basell PMG6040 polypropylene maleic anhydride graft, having a melt flow rate of 400 grams per 10 minutes and a maleic anhydride content of about 1.9 weight percent
Lyondell Basell PX6002 is a let-down product made from or containing (i) about 10 weight percent, based upon the total weight of the let-down product, of Lyondell Basell PMG6040 polypropylene maleic anhydride graft; (ii) about 69.8 weight percent, based upon the total weight of the let-down product, of Lyondell Basell Profax SR257 polypropylene random copolymer having a specific gravity of 0.90 and a melt flow rate of 2.0 grams per 10 minutes; (iii) about 20 weight percent, based upon the total weight of the let-down product, of ExxonMobil Company's VISTALON™ 722 ethylene propylene rubber, having 72 weight percent ethylene recurring units, based upon the total weight of the ethylene propylene rubber and a melt index of 1.0 grams per 10 minutes; and (iv) about 0.2 weight percent, based upon the total weight of the let-down product, of additives

TABLE 1

| Polyolefin-based maleic anhydride graft | YI (Original) | YI (Modified) |
|---|---|---|
| PMG2372 polyethylene-based graft | 16.2 | 13.0 |
| PMG2472 - 1 polyethylene-based graft | 16.7 | 10.1 |
| PMG2472 - 2 polyethylene-based graft | 25.4 | 16.7 |
| PMG6040 polypropylene-based graft | 89 | 70 |
| PX6002 polypropylene-based graft | 32 | 21 |

### Continuous Process Examples

For each example of the continuous process, a sample of polyolefin-based maleic anhydride graft was selected and introduced into a hopper of extruder. An amount of water, having a weight equal to about 0.1 weight percent of the polyolefin-based maleic anhydride graft, was injected into the extruder as the polyolefin-based maleic anhydride graft was conveyed through the extruder. The extruder's screw speed was 200 rpm. The extruder had six heated zones ranging in temperature from 150 degrees Celsius to 230 degrees Celsius according to following profile:

| Z1 | /Z2 | /Z3 | /Z4 | /Z5 | /Z6 | /die |
|---|---|---|---|---|---|---|
| 150 | /170 | /190 | /230 | /230 | /230 | /230 |

After collecting the resulting reaction product from the extruder, the product was analyzed by Fourier Transform Infrared Analysis and for its yellowness index (YI).

The samples for evaluation were prepared from the following polyolefin-based maleic anhydride grafts:
Lyondell Basell PX6002

TABLE 2

| Polyolefin-based maleic anhydride graft | YI (Original) | YI (Modified) |
|---|---|---|
| PX6002 polypropylene-based graft | 31 | 25 |

It should be understood that various changes, substitutions and alterations can be made herein without departing from the spirit and scope of this disclosure as defined by the appended claims. Moreover, the scope of the present application is not intended to be limited to the embodiments of the process, machine, manufacture, composition of matter, means, methods and steps described in the specification. As one of the ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

What is claimed is:

1. A process for modifying a polyolefin-based composition comprising the steps of:
(A) a selection step comprising selecting a first polyolefin-based composition comprising:
(i) a first polyolefin-based maleic anhydride graft having
(a) a yellowness index measurable according to ASTM D6290 and subject to calculation according to ASTM E313 and
(b) an amount of covalently-bonded maleic anhydride substituents available for hydrolysis;
(B) an introduction step comprising introducing the first polyolefin-based composition into a mixing chamber;
(C) a first mixing step comprising admixing water into the mixing chamber to form a water-containing polyolefin-based composition;
(D) a wetting step comprising heating and agitating the water-containing polyolefin-based composition;
(E) a reaction step comprising reacting the water with at least some of the maleic anhydride substituents to form maleic acid substituents, thereby yielding a modified polyolefin-based maleic anhydride graft having a yellowness index lower than the yellowness index of the first polyolefin-based maleic anhydride graft; and
(F) a collection step comprising collecting the modified polyolefin-based maleic anhydride graft, thereby yielding a modified polyolefin-based composition.

2. The process for modifying a polyolefin-based composition of claim 1, wherein the polyolefin-based maleic anhydride graft is selected from the group consisting of polyethylene-based maleic anhydride grafts and polypropylene-based maleic anhydride grafts.

3. The process for modifying a polyolefin-based composition of claim 1, wherein the water is added in an amount at least stoichiometric to the amount of the covalently-bonded maleic anhydride substituents available for hydrolysis.

4. The process for modifying a polyolefin-based composition of claim 1, wherein the modified polyolefin-based composition has a yellowness index less than about 65.

5. The process for modifying a polyolefin-based composition of claim 1, wherein the process is a batch process or a continuous process.

6. The process for modifying a polyolefin-based composition of claim 1, further comprising the step of:
(G) a second mixing step comprising admixing a second polyolefin-based composition comprising a second polyolefin, thereby yielding a let-down product of the polyolefin-based maleic anhydride graft and further modifying the modified polyolefin-based composition.

7. The process for modifying a polyolefin-based composition of claim 6, wherein the polyolefin-based maleic anhydride graft is present in an amount from about 1 weight percent to about 20 weight percent, relative to the total weight of the modified polyolefin-based composition.

8. The process for modifying a polyolefin-based composition of claim 6, wherein
(A) the polyolefin-based maleic anhydride graft is a polyethylene-based maleic anhydride graft copolymer; and
(B) the second polyolefin is a linear low density polyethylene.

9. The process for modifying a polyolefin-based composition of claim 8, wherein the modified polyolefin-based composition has a yellowness index less than about 15.

10. The process for modifying a polyolefin-based composition of claim 6, wherein
(A) the polyolefin-based maleic anhydride graft is a polypropylene-based maleic anhydride graft copolymer; and
(B) the second polyolefin is a propylene polymer selected from the group consisting of propylene homopolymers, propylene random copolymers, and propylene impact copolymers.

11. The process for modifying a polyolefin-based composition of claim 9, wherein the modified polyolefin-based composition has a yellowness index less than about 15.

12. A modified polyolefin-based composition prepared by a process comprising the steps of:
(A) a selection step comprising selecting a first polyolefin-based composition comprising:
(i) a first polyolefin-based maleic anhydride graft having
(a) a yellowness index measurable according to ASTM D6290 and subject to calculation according to ASTM E313 and
(b) an amount of covalently-bonded maleic anhydride substituents available for hydrolysis;
(B) an introduction step comprising introducing the first polyolefin-based composition into a mixing chamber;
(C) a first mixing step comprising admixing water into the mixing chamber to form a water-containing polyolefin-based composition;
(D) a wetting step comprising heating and agitating the water-containing polyolefin-based composition;
(E) a reaction step comprising reacting the water with at least some of the maleic anhydride substituents to form maleic acid substituents, thereby yielding a modified polyolefin-based maleic anhydride graft having a yellowness index lower than the yellowness index of the first polyolefin-based maleic anhydride graft; and
(F) a collection step comprising collecting the modified polyolefin-based maleic anhydride graft, thereby yielding a modified polyolefin-based composition.

13. A tie-layer adhesive comprising:
(A) the modified polyolefin-based composition according to claim 12.
